(19) United States
(12) Patent Application Publication
(10) Pub. No.: US 2025/0190954 A1
(43) Pub. Date: Jun. 12, 2025

(54) METHODS AND SYSTEMS FOR RECYCLING ARTICLES OF AEROSOL PROVISION SYSTEMS

(71) Applicant: NICOVENTURES TRADING LIMITED, London (GB)

(72) Inventors: Paul TOLLERFIELD, London (GB); Sally BELL, London (GB); Nejat ERGUVEN, London (GB); Joseph Peter SUTTON, London (GB)

(21) Appl. No.: 18/845,668

(22) PCT Filed: Mar. 13, 2023
(86) PCT No.: PCT/GB2023/050585

§ 371 Date: Sep. 10, 2024

(30) Foreign Application Priority Data
Mar. 17, 2022 (GB) 2203691.7

(51) Int. Cl. G06Q 10/30

(52) U.S. Cl. CPC G06Q 10/30

(57) ABSTRACT

A recycling method comprises providing a receptacle for receiving at least articles of aerosol provision systems, receiving, by the receptacle, one or more articles, in response to the number of articles received by the receptacle meeting a storage limit, sending a notification to a recycling centre or to one or more devices associated with the recycling centre to indicate the receptacle has articles for collection, and sending the articles from the receptacle to the recycling centre.

### TECHNICAL FIELD The present invention relates to a recycling method and a recycling system.

### BACKGROUND

Electronic aerosol provision systems such as electronic cigarettes (e-cigarettes) generally contain an aerosol-generating material, such as a reservoir of a source liquid containing a formulation, typically including nicotine, or a solid material such as a tobacco-based product, from which an aerosol is generated for inhalation by a user, for example through heat vaporisation. Thus, an aerosol provision system will typically comprise an aerosol generator, e.g. a heating element, arranged to aerosolise a portion of aerosol-generating material to generate an aerosol in an aerosol generation region of an air channel through the aerosol provision system. As a user inhales on the device and electrical power is supplied to the aerosol generator, air is drawn into the device through one or more inlet holes and along the air channel to the aerosol generation region, where the air mixes with the vaporised aerosol generator and forms a condensation aerosol. The air drawn through the aerosol generation region continues along the air channel to a mouthpiece, carrying some of the aerosol with it, and out through the mouthpiece for inhalation by the user.

It is common for aerosol provision systems to comprise a modular assembly, often having two main functional parts, namely an aerosol provision device and an article. Typically, the article will comprise the article aerosol-generating material and the aerosol generator (heating element), while the aerosol provision device part will comprise longer-life items, such as a rechargeable battery, device control circuitry and user interface features. The aerosol provision device may also be referred to as a reusable part or battery section and the article may also be referred to as a consumable, disposable/replaceable part, cartridge or cartomiser.

The aerosol provision device and article are mechanically coupled together at an interface for use, for example using a screw thread, bayonet, latched or friction fit fixing. When the aerosol-generating material in an article has been exhausted, or the user wishes to switch to a different article having a different aerosol-generating material, the article may be removed from the aerosol provision device and a replacement article may be attached to the device in its place.

The user needs to be able to safely dispose of and recycle the article when it has reached the end of its usable life.

Various approaches are described herein which seek to help address or mitigate some of the issues discussed above.

### SUMMARY

The disclosure is defined in the appended claims.

In accordance with some embodiments described herein, there is provided a recycling method comprising providing a receptacle for receiving at least articles of aerosol provision systems, receiving, by the receptacle, one or more articles, in response to the number of articles received by the receptacle meeting a storage limit, sending a notification to a recycling centre or to one or more devices associated with the recycling centre to indicate the receptacle has articles for collection, and sending the articles from the receptacle to the recycling centre.

The method can further comprise providing a user of an aerosol provision system a shipping label for adhering to the article prior to the receptacle receiving the article from the user.

The receptacle can comprise one or more bags for receiving the articles, and where in the bags are sealed prior to sending the articles to the recycling centre.

The method can further comprise providing a notification to the user in response to the user passing proximate to the receptacle.

The articles can be integrally formed with an aerosol provision device to form an aerosol provision system, and wherein sending the notification to a recycling centre or to one or more devices associated with the recycling centre to indicate the receptacle has articles for collection includes sending the notification a recycling centre or to one or more devices associated with the recycling centre in response to the number of integrally formed articles and aerosol provision devices received by the receptacle meeting a storage limit.

In accordance with some embodiments described herein, there is provided a method for notifying when a receptacle for receiving at least articles of aerosol provision systems reaches a storage limit, the method comprising providing the receptacle for receiving at least articles of aerosol provision systems; determining when the number of articles received by the receptacle meets a storage limit; and in response to the number of articles received by the receptacle meeting the storage limit, sending a notification to a recycling centre or to one or more devices associated with the recycling centre to indicate the receptacle has articles for collection.

In accordance with some embodiments described herein, there is provided a recycling system comprising a recycling centre and a receptacle configured to receive one or more articles for aerosol provision systems, and send, in response to the number of articles received by the receptacle meeting a storage limit, a notification to the recycling centre to indicate the receptacle has articles for collection, wherein the articles are sent from the receptacle to the recycling centre in response to the notification.

In accordance with some embodiments described herein, there is provided a receptacle configured to: receive one or more articles for aerosol provision systems; determine when the number of articles received by the receptacle meets a storage limit; and in response to the number of articles received by the receptacle meeting the storage limit, send a notification to a recycling centre or to one or more devices associated with the recycling centre to indicate the receptacle has articles for collection.

In accordance with some embodiments described herein, there is provided a recycling method comprising providing a receptacle for receiving at least articles of aerosol provision systems; receiving, by the receptacle, one or more articles; in response to the weight of articles received by the receptacle meeting a storage limit, sending a notification to a recycling centre or to one or more devices associated with the recycling centre to indicate the receptacle has articles for collection; and sending the articles from the receptacle to the recycling centre.

The method can further comprise providing a user of an aerosol provision system a shipping label for adhering to the article prior to the receptacle receiving the article from the user.

The receptacle can comprise one or more bags for receiving the articles, and where in the bags are sealed prior to sending the articles to the recycling centre.

The method can further comprise providing a notification to the user in response to the user passing proximate to the receptacle.

The articles can be integrally formed with an aerosol provision device to form an aerosol provision system, and wherein sending the notification to a recycling centre or to one or more devices associated with the recycling centre to indicate the receptacle has articles for collection includes sending the notification a recycling centre or to one or more devices associated with the recycling centre in response to the weight of integrally formed articles and aerosol provision devices received by the receptacle meeting a storage limit.

In accordance with some embodiments described herein, there is provided a method for notifying when a receptacle for receiving at least articles of aerosol provision systems reaches a storage limit, the method comprising providing the receptacle for receiving at least articles of aerosol provision systems; determining when the weight of articles received by the receptacle meets a storage limit; and in response to the number of articles received by the receptacle meeting the storage limit, sending a notification to a recycling centre or to one or more devices associated with the recycling centre to indicate the receptacle has articles for collection.

In accordance with some embodiments described herein, there is provided a recycling system comprising: a recycling centre; and a receptacle configured to: receive one or more articles for aerosol provision systems; and send, in response to the weight of articles received by the receptacle meeting a storage limit, a notification to the recycling centre to indicate the receptacle has articles for collection; wherein the articles are sent from the receptacle to the recycling centre in response to the notification.

In accordance with some embodiments described herein, there is provided a receptacle configured to: receive one or more articles for aerosol provision systems; and determine when the weight of articles received by the receptacle meets a storage limit; and in response to the number of articles received by the receptacle meeting the storage limit, send a notification to a recycling centre or to one or more devices associated with the recycling centre to indicate the receptacle has articles for collection.

These aspects and other aspects will be apparent from the following detailed description. In this regard, particular sections of the description are not to be read in isolation from other sections.

### BRIEF DESCRIPTION OF DRAWINGS

Embodiments of the invention will now be described, by way of example only, with reference to accompanying drawings, in which:

FIG. 1 is a schematic diagram of an aerosol provision system;

FIG. 2 is a schematic diagram of a system comprising an aerosol system;

FIG. 3 is a flow diagram of a recycling method;

FIG. 4 is a schematic diagram of a system comprising an aerosol system according to a second implementation;

FIG. 5 is a flow diagram of a recycling method according to a second implementation.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of articles and systems discussed herein which are not described in detail may be implemented in accordance with any conventional techniques for implementing such aspects and features.

The present disclosure relates to aerosol provision systems, which may also be referred to as vapour provision systems, such as e-cigarettes. Throughout the following description the term “e-cigarette” or “electronic cigarette” may sometimes be used, but it will be appreciated this term may be used interchangeably with aerosol provision system and electronic aerosol provision system.

As noted above, aerosol provision systems (e-cigarettes) often comprise a modular assembly including both a reusable part (aerosol provision device) and a replaceable (disposable) or refillable cartridge part, referred to as an article. Systems conforming to this type of two-part modular configuration may generally be referred to as two-part systems or devices. It is also common for electronic cigarettes to have a generally elongate shape. For the sake of providing a concrete example, certain embodiments of the disclosure described herein comprise this kind of generally elongate two-part system employing refillable cartridges. However, it will be appreciated the underlying principles described herein may equally be adopted for other electronic cigarette configurations, for example modular systems comprising more than two parts, as devices conforming to other overall shapes, for example based on so-called box-mod high performance devices that typically have a more boxy shape, or even systems comprising one part where the aerosol provision device and article are integrally formed with one another.

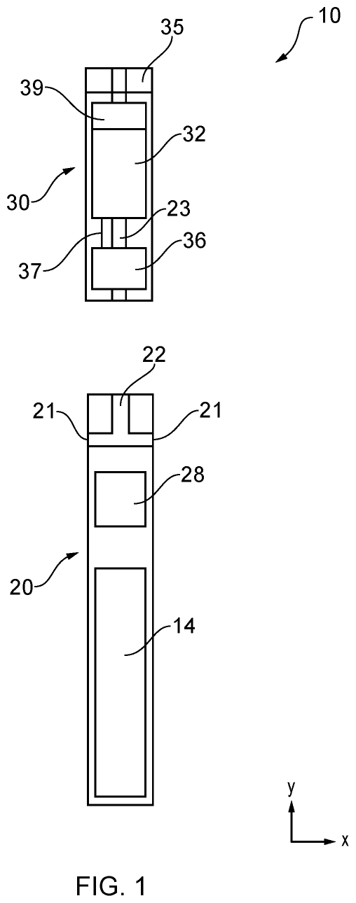

FIG. 1 is a highly schematic diagram (not to scale) of an example aerosol provision system 10, such as an e-cigarette, to which embodiments are applicable. The aerosol provision system 10 has a generally cylindrical shape, extending along a longitudinal or y axis as indicated by the axes (although aspects of the invention are applicable to e-cigarettes configured in other shapes and arrangements), and comprises two main components, namely an aerosol provision device 20 and an article 30.

The article 30 comprises or consists of aerosol-generating material 32, part or all of which is intended to be consumed during use by a user. An article 30 may comprise one or more other components, such as an aerosol-generating material storage area 39, an aerosol-generating material transfer component 37, an aerosol generation area, a housing, a wrapper, a mouthpiece 35, a filter and/or an aerosol-modifying agent.

An article 30 may also comprise an aerosol generator 36, such as a heating element, that emits heat to cause the aerosol-generating material 32 to generate aerosol in use. The aerosol generator 36 may, for example, comprise combustible material, a material heatable by electrical conduction, or a susceptor. It should be noted that it is possible for the aerosol generator 36 to be part of the aerosol provision device 20 and the article 30 then May comprise the aerosol-generating material storage area 39 for the aerosol-generating material 32 such that, when the article 30 is coupled with the aerosol provision device 20, the aerosol-generating material 32 can be transferred to the aerosol generator 36 in the aerosol provision device 20. It should be appreciated that the aerosol generator 36 may encompass an aerosol generator other than a heater. More generally, an aerosol generator is an apparatus configured to cause aerosol to be generated from the aerosol-generating material. In some other embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

Aerosol-generating material is a material that is capable of generating aerosol, for example when heated, irradiated or energized in any other way. The aerosol-generating material 32 may, for example, be in the form of a solid, liquid or gel which may or may not contain an active substance and/or flavourants. In some embodiments, the aerosol-generating material 32 may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material 32 may for example comprise from about 50 wt %, 60 wt % or 70 wt % of amorphous solid, to about 90 wt %, 95 wt % or 100 wt % of amorphous solid.

The aerosol-generating material comprises one or more ingredients, such as one or more active substances and/or flavourants, one or more aerosol-former materials, and optionally one or more other functional materials such as pH regulators, colouring agents, preservatives, binders, fillers, stabilizers, and/or antioxidants.

The active substance as used herein may be a physiologically active material, which is a material intended to achieve or enhance a physiological response. The active substance may for example be selected from nutraceuticals, nootropics, and psychoactives.

The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

The aerosol provision device 20 includes a power source 14, such as a battery, configured to supply electrical power to the aerosol generator 36. The power source 14 in this example is rechargeable and may be of a conventional type, for example of the kind normally used in electronic cigarettes and other applications requiring provision of relatively high currents over relatively short periods. The power source 14 may be recharged through the charging port (not illustrated), which may, for example, comprise a USB connector.

The aerosol provision device 20 includes device control circuitry 28 configured to control the operation of the aerosol provision system 10 and provide conventional operating functions in line with the established techniques for controlling aerosol provision systems such as electronic cigarettes. The device control circuitry (processor circuitry) 28 may be considered to logically comprise various sub-units/circuitry elements associated with different aspects of the electronic cigarette's operation. For example, depending on the functionality provided in different implementations, the device control circuitry 28 may comprise power source control circuitry for controlling the supply of electrical power from the power source 14 to the aerosol generator 36, user programming circuitry for establishing configuration settings (e.g. user-defined power settings) in response to user input, as well as other functional units/circuitry associated functionality in accordance with the principles described herein and conventional operating aspects of electronic cigarettes. It will be appreciated the functionality of the device control circuitry 28 can be provided in various different ways, for example using one or more suitably programmed programmable computer(s) and/or one or more suitably configured application-specific integrated circuit(s)/circuitry/chip(s)/chipset(s) configured to provide the desired functionality.

The aerosol provision device 20 has an interface configured to receive the article 30, thereby facilitating the coupling between the aerosol provision device 20 and the article 30. The interface is located on a surface of the aerosol provision device 20.

The housing of the article 30 has a surface configured to be received by the interface on the aerosol provision device 20 in order to facilitate coupling between the article 30 and the aerosol provision device 20. The surface of the article may be configured to be a size and/or shape that mirrors the size and/or shape of the interface in order to facilitate coupling between the aerosol provision device 20 and the article 30. For example, the interface may comprise a cavity, chamber or other space on the surface of the aerosol provision device 20. The surface of the article 30 can then be configured to be a size and shape that mirrors the size and shape of the cavity in order for the surface of the article 30 to be inserted into the cavity.

Although not illustrated, the interface of the aerosol provision device 20 and the surface of the article 30 may have complementary features to reversibly attach and mate the article 30 to the aerosol provision device 20, such as a screw thread, bayonet fitting, latched or friction fit fixing or other fastening means.

The interface also comprises one or more connectors, such as contact electrodes, connected via electrical wiring to the control circuitry 28 and the power source 14. The article 30 also comprises one or more connectors, such as contact electrodes, connected via electrical wiring to the aerosol generator 36. In use, the article 30 is received by the interface of the aerosol provision device 20, thereby coupling the aerosol provision device 20 and the article 30. This results in the connectors on the article 30 mating with the connectors on the aerosol provision device 20, thereby allowing electrical power and electrical current to be supplied from the power source 14 of the aerosol provision device 20 to the aerosol generator 36 of the article 30.

The housing of the article 30 has a surface configured to engage with an interface on the aerosol provision device 20 in order to facilitate coupling between the article 30 and the aerosol provision device 20. In other words, the aerosol provision device 20 is configured to receive the article 30, via the interface and the surface of the article is proximate to the interface on the aerosol provision device 20 when the article 20 is received by the interface. The aerosol provision system 10 includes one or more air inlets 21, located on one or more of the aerosol provision device 20 and the article 30. In use, as a user inhales on the mouthpiece 35, air is drawn into the aerosol provision system 10 through the air inlets 21 and along an air channel 23 to the aerosol generator 36, where the air mixes with the vaporised aerosol-generating material 32 and forms a condensation aerosol. The air drawn through the aerosol generator 36 continues along the air channel 23 to a mouthpiece 35, carrying some of the aerosol with it, and out through the mouthpiece 35 for inhalation by the user.

By way of a concrete example, the article 30 comprises a housing (formed, e.g., from a plastics material), an aerosol-generating material storage area 39 formed within the housing for containing the aerosol-generating material 32 (which in this example may be a liquid which may or may not contain nicotine), an aerosol-generating material transfer component 37 (which in this example is a wick formed of e.g., glass or cotton fibres, or a ceramic material configured to transport the liquid from the reservoir using capillary action), an aerosol-generating area containing the aerosol generator 36, and a mouthpiece 35. Although not shown, a filter and/or aerosol modifying agent (such as a flavour imparting material) may be located in, or in proximity to, the mouthpiece 35. The aerosol generator 36 of this example comprises a heater element formed from an electrically resistive material (such as NiCr8020) spirally wrapped around the aerosol-generating material transfer component 37, and located in an air channel 23. The area around the heating element and wick combination is the aerosol-generating area of the article 30.

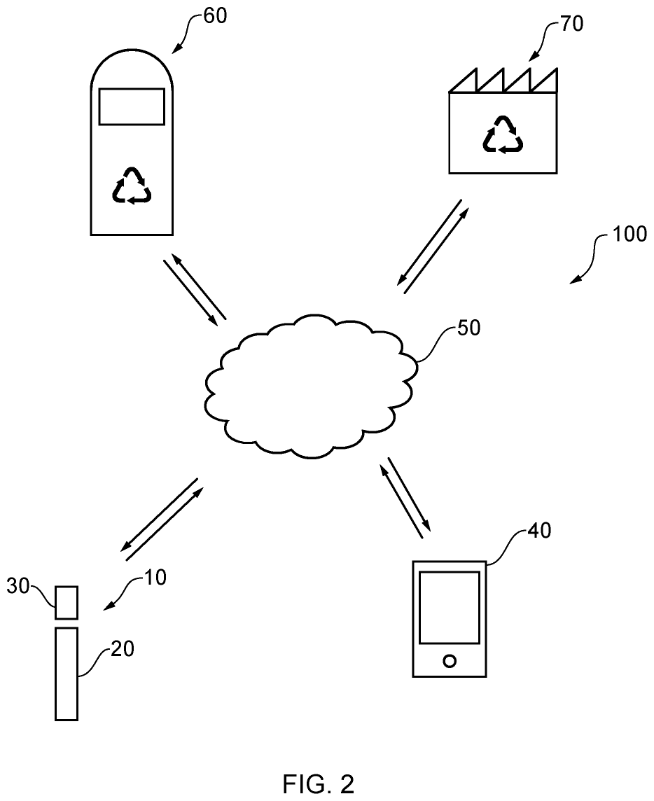

FIG. 2 is a schematic diagram of a system 100 comprising an aerosol provision system 10, where the same reference signs have been used to denote same components in FIGS. 1 and 2. System 100 comprises an aerosol provision system 10, a computing device 40 and a network 50. Computing device 40 can be a device associated with the aerosol provision system 10, for example a mobile device, handheld computing device, or other electronic device. Computing device 40 is configured to communicate with the aerosol provision system 10 via the network 50. For example, computing device 40 can comprise a communications interface configured to communicate with the device control circuitry 28 of the aerosol provision device 20 via the network. The computing device 40 and the aerosol provision system 10 can communicate using a suitable wireless communications protocol such as Wi-Fi, Bluetooth, RFID, NFC.

The computer device 40 may be associated with a user of the aerosol provision system 10 such that the aerosol provision system 10 and the computer device 40 may be associated with one another, for example via a user profile of the user of aerosol provision system 10.

System 100 also comprises a recycling system. The recycling system comprises one or more receptacles 60 and a recycling centre 70. The one or more receptacles 60 are for receiving at least articles 30 of aerosol provision systems 10. In other words, the receptacles 60 are configured to receive at least one or more articles 30 for aerosol provision systems 10. In other implementations, the receptacles 60 may be configured to additionally receive the aerosol provision devices 20 of the aerosol provision system 10, e.g., if the article 30 is integrally formed with the aerosol provision device 20. The receptacles may be located outside, for example on a pavement or road, and/or inside a building, for example inside a shop where articles 30 are sold or inside an office. The receptacles 60 may also form part of a larger recycling bin, with one receptacle 60 for articles 30 of aerosol provision systems 10 and other receptacles for other products, such as batteries, glass or plastics. The receptacles 60 may be distributed around an area to create a network of receptacles 60 such that the distance a user need to travel to find/reach a receptacle 60 is minimised. The receptacles 60 are configured to communicate with the aerosol provision system 10 and/or the computer device 40 via the network 50. For example, each receptacle 60 can comprise a communications interface configured to communicate with device control circuitry 28 of the aerosol provision device 20 and the computing device 40 via the network 50. The receptacles 60 can communicate using a suitable wireless communications protocol such as Wi-Fi, Bluetooth, RFID, NFC.

The recycling centre 70 is a plant, factory, or other structure configured to receive waste products and other materials to be recycled for reuse. The recycling centre 70 may be a dedicated structure for recycling articles 30 and other components of aerosol provision systems 10, or the recycling centre 70 may be configured to accept and recycle multiple different waste products, with articles 30 for aerosol provision systems 10 being one of the accepted waste products. The recycling centre 70 is configured to communicate with the receptacles 60 via the network 50, for example using a suitable wireless communications protocol such as Wi-Fi, Bluetooth, RFID, NFC. The recycling centre 70 can also be configured to communicate with one or more of the aerosol provision system 10 and the computer device 40 via network 50.

When an article 30 has reached the end of its usable life (i.e. the article has expired), the user of the aerosol provision system 10 is able to place, drop or otherwise deposit the article 30 into the receptacle 60. The article 30 may be considered to be expired when substantially all of the aerosol generating material in the article 30 has been depleted, when the article 30 has been used a predetermined number of times, and/or the article 30 has been refilled with aerosol generating material a predetermined number of times. The aerosol provision device 20 and/or the computing device 40 can be configured to determine that the article the aerosol provision system 10 has expired.

For example, the computing device 40 can be configured to determine that an article 30 for aerosol provision system 10 has expired based on an indication received from the aerosol provision system 10. For example, the device control circuitry 28 can send an indication related to the article 30 to the computing device 40, and the computing device 40 is configured to determine that the article 30 needs to be replaced based on the received indication. For example, the indication can comprise an indication of the amount of aerosol generating material contained within the article 30, and the computing device 40 is configured to determine that the article 30 needs to be replaced when the amount of aerosol generating material in the article 30 is zero or less than a predetermined amount, for example 1, 5 or 10% of the capacity of the article 30. Alternatively, the indication can comprise an indication of a number of times power has been supplied to the aerosol generator 36 of the article 30 and/or a duration that power has been supplied to the aerosol generator 36 of the article 30. As it will be appreciated, the aerosol generator 36 is used each time the user inhales on the aerosol provision system 10, and the amount of aerosol generating material consumed can be calculated based on the number and duration of uses of the aerosol generator 36. The computing device 40 can then be configured to use this information to determine that the article 30 has expired and needs to be replaced.

The device control circuitry 28 can be configured to send the indication to the computing device 40 at a predetermined interval, such as every 5, 10, 30 minutes or hour, or the device control circuitry 28 can be configured to send the indication to the computing device 40 in response to a particular event, such as the device 20 being turned on, or the user inhaling on the aerosol provision system 10.

As described above, the determination that the article 30 for the aerosol provision system 10 has expired can be performed by the aerosol provision device 20, for example by the device control circuitry 28 in a similar fashion as described above with respect computing device 40.

Having determined that the article 30 has expired, the computing device 40 and/or the device control circuitry 28 can be configured to provide a notification indicating that the article 30 has expired to the user of the aerosol provision system 10. For example, the notification can be provided on a display screen of the computer device 40 and/or on a display screen or user interface of the aerosol provision system 10. The computing system 40 can be configured to instruct the aerosol provision system 10, for example by communicating with the device control circuity 28 via the network 50, to provide the notification on the display screen of the aerosol provision system 10. Equally, the device control circuit 28 can be configured to instruct the computing device 40, for example by communicating via network 50, to provide the notification on a display screen of the computing device 40. The notification therefore informs the user that the article 30 has expired, and prompts the user to place the article 30 into a receptacle 60.

The computing device 40 and/or the aerosol provision device 20 can also be configured to determine that the article 30 has expired based on an indication received from the user of the aerosol provision system 10. The indication may be provided on the computing device 40 or provided on the aerosol provision device 20, for example via an input means on the computing device 40, and the computing device 40 configured to determine that the article 30 needs to be replaced in response to receiving the indication. Alternatively, or in addition, the indication may be provided on the aerosol provision device 20, for example via an input means on the aerosol provision device 20.

In response to determining that the article 30 needs to be replaced, a location of a receptacle 60 can be determined, for example by the aerosol provision device 20 and/or the computing device 40. The aerosol provision device 20 and/or the computing device 40 can communicate with the one or more receptacles 60 via the network 50 in order to determine the location of the receptacles 60. For example, the aerosol provision device 20 and/or the computing device 40 can communicate with the one more receptacles 60 using Bluetooth, NFC, Wi-Fi or other communication protocols in order to determine the location of one or more receptacles 60.

The location of a receptacle 60 can also be determined based on the location of the aerosol provision device 20 and/or the computing device 40. For example, the location of the aerosol provision device 20 can be determined using a GPS interface of the aerosol provision device 20, or by sending a request to the computing device 40 for location information. The computing device 40 can then determine its location using GPS interface of the computing device 40, and then send this location to the vessel provision device 20. Equally, the computing device 40 can determine its location using a GPS interface, by cellular triangulation, or using a Wi-Fi positioning system. Having determined the location of the aerosol provision device 20 and/or the computing device 40, the location of a receptacle 60 can be determined. For example, the location of the aerosol provision device 20 and/or the computing device 40 can be compared to a database of known locations of receptacles 60 in order to determine the nearest receptacle 60 or one or more receptacles 60 proximate to the aerosol provision device 20 and/or the computer device 40 (i.e. the user).

Having determined the location of the one or more receptacles 60, a notification can be provided to the user informing the user as to the location of one or more the receptacles 60. For example, the notification can be provided on a display screen of the computer device 40 and/or on a display screen of the aerosol provision system 10. The notification may contain information related to location of each receptacle 60, or a subset of the receptacles 60 or the location of a single receptacle 60, for example the receptacle 60 closest to the user. The notification may also comprise direction information to direct the user or otherwise allow the user to navigate to the receptacle 60. Once at the location of the receptacle 60, the user is able to deposit the expired article 30 into the receptacle 60.

In some cases, a notification can be provided to the user in response to the user passing approximate to a receptacle 60. For example, the computing device 40 and/or the aerosol provision device 20 can detect when a receptacle 60 is within communication range, for example based on a wireless signal strength via the network 50 such as Bluetooth, NFC, Wi-Fi. In response to detecting a signal from a receptacle 60, a notification can be provided to the user, for example informing the user as to the location of the receptacle 60 as described above.

As described above, each receptacle 60 is configured to receive articles 30. Prior to the article 30 being received by the receptacle 60 from the user, a shipping label can be provided to the user of aerosol provision system 10 for adhering, sticking or otherwise attaching to the article 30. The shipping label can be generated and provided to the user by the receptacle 60, for example from a printer of the receptacle 60. Alternatively, or in addition, the shipping label can be provided to the user by the computing device 40. For example, the computing device 40 can generate a shipping label and send a notification to the user indicating that the user is to print the shipping label and adhere shipping label to the article 30 before placing the article into receptacle 60. The computing device 40 can be configured to generate the shipping label in response to the determination that the article has expired. Once the shipping label has been provided to the user, the user can adhere the shipping label to the article 30 and the article 30 can be received by the receptacle 60.

In response to the number of articles received by the receptacle 60 meeting a storage limit, the receptacle 60 is configured to send a notification to the recycling centre 70 or to one or more devices associated with the recycling centre 70 to indicate the receptacle 60 has articles for collection. As described above, the receptacle 60 can communicate with the recycling centre 70 via the network 50. In addition, or alternatively, the receptacle 60 may communicate with one or more devices associated with the recycling centre, e.g., one or more smartphones belonging to registered employees of the recycling centre 70. In this case, the receptacle 60 may be provided with communication details (e.g., telephone numbers, IP addresses, etc.) associated with the one or more devices, which may be obtained from a server (not shown) coupled to the network 50 or from the recycling centre 70. Alternatively, such notifications may be forwarded from the recycling centre 70 to the one or more devices associated with the recycling centre.

In response to receiving the notification, the articles can be sent or otherwise transported from the receptacle 60 to the recycling centre 70. For example, in response to receiving the notification that the receptacle 60 has articles for collection, a courier or other delivery service can be sent from the recycling centre 70 to the receptacle 60 in order to collect the articles 30 from the receptacle 60 and transport the articles 30 to the recycling centre 70. The recycling centre 70 is then configured to receive the articles 30 from the receptacle 60 and recycle the articles 30 such that they can be reused. For example, the recycling centre 70 may disassemble each article into one or more components to allow the components to be disposed of and/or recycled as appropriate. The components can be grouped based on the materials or other properties of each component. For example, all the components of the articles 30 made from the same or similar materials can be grouped together as they can be recycled or disposed of in the same way.

The receptacles 60 can store the articles 30 after having received the articles 30 and before the articles 30 are collected and sent to the recycling centre 70. The articles 30 can be stored in bags, boxes, tanks or other storage means of the receptacle 60. For example, the receptacle 60 can comprise one or more bags for receiving the articles. The receptacle 60 can then be configured to seal the bags prior to sending the articles to the recycling centre 70. Alternatively, one or more bags can be provided to the user so that the user is able to put the articles 30 into a bag before depositing them into the receptacle 60. For example, the receptacle 60 can comprise a bag dispenser so that the user is able to take a bag from the dispenser in order to put the articles 30 into a bag. In the case described above where a shipping label is provided to the user, the user can adhere the shipping label to the bag before depositing the bag into the receptacle. Putting the articles 30 into a bag prevents leakage of any residual aerosol generating material or other fluid from the articles 30 whilst they are stored in the receptacle 60 and/or sent to the recycling centre 70. The recycling centre 70 is then configured to receive the bags containing the articles 30 and unpack the articles from the bags prior to recycling and/or disposing of the articles 30.

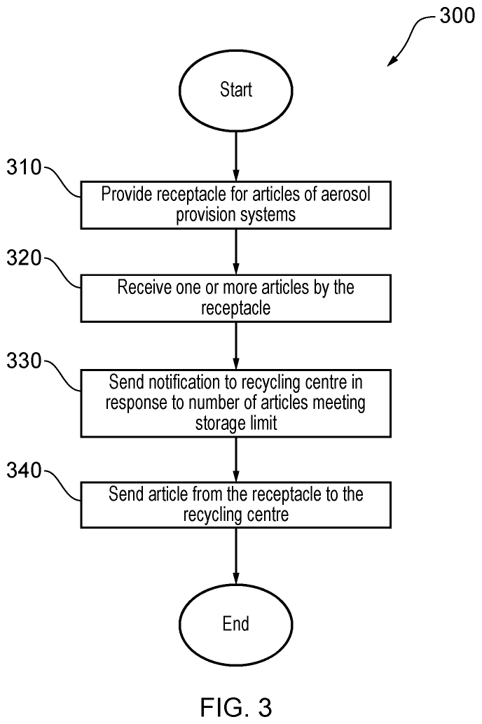

FIG. 3 is a flow diagram of a method 300 for recycling articles of an aerosol provision system, for example article 30. The method begins at step 310, where a receptacle for articles of aerosol provision systems is provided. At step 320, one of more articles are received by the receptacle. At step 330, a notification is sent to a recycling centre in response to the number of articles received by the receptacle meeting a storage limit. The notification indicates the receptacle has articles for collection. At step 340, the articles are sent form the receptacle to the recycling centre. The method then ends.

As described above, the present disclosure relates to (but it not limited to) a recycling method comprising providing a receptacle for receiving at least articles of aerosol provision systems, receiving, by the receptacle, one or more articles, in response to the number of articles received by the receptacle meeting a storage limit, sending a notification to a recycling centre or to one or more devices associated with the recycling centre to indicate the receptacle has articles for collection, and sending the articles from the receptacle to the recycling centre.

The above has described a system 100 comprising a recycling system comprising one or more receptacles 60 and a recycling centre 70, where the receptacle 60 is configured to send a notification to the recycling centre 70 or to one or more devices associated with the recycling centre 70 to indicate the receptacle 60 has articles for collection in response to the number of articles received by the receptacle 60 meeting a storage limit. However, the configuration of the one or more receptacles 60 is not limited to the described configuration.

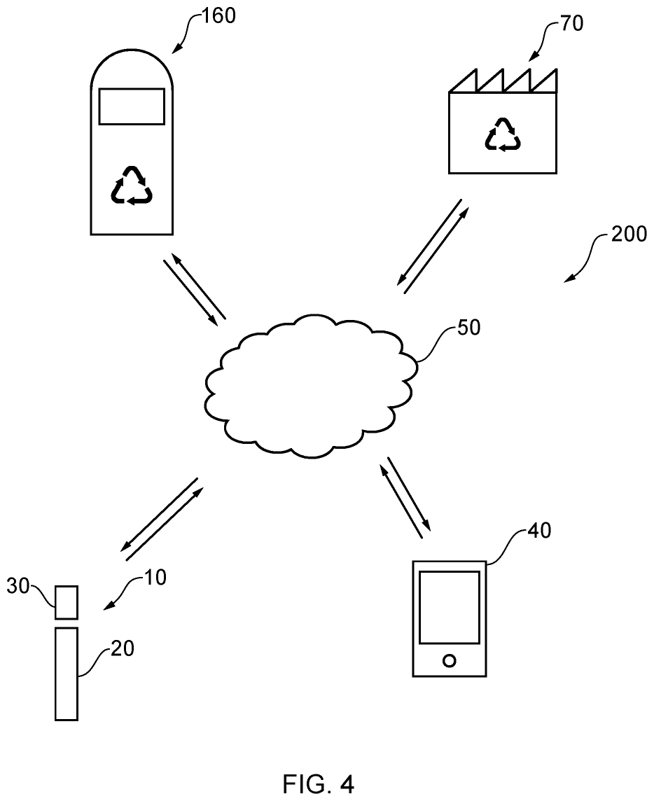

FIG. 4 is a schematic diagram of a system 200 comprising an aerosol provision system 10, a computing device 40, network 50, and a recycling system comprising one or more receptacles 160 and a recycling centre 70. System 100 is similar to system 100 of FIG. 2. The aerosol provision system 10, computing device 40, network 50 and recycling centre 70 are substantially the same as their counterparts described in FIG. 2. A repetition of the features of the aerosol provision system 10, computing device 40, network 50 and recycling centre 70 are not repeated herein. Instead, the differences between system 100 and system 200 are described below.

The one or more receptacles 160 are similar to the one or more receptacles 60 described in FIG. 2. That is, the one or more receptacles 160 are similarly for receiving at least articles 30 of aerosol provision systems 10. In other words, as above, the receptacles 160 are configured to receive at least one or more articles 30 for aerosol provision systems 10, or as in other implementations, the receptacles 160 may be configured to additionally receive the aerosol provision devices 20 of the aerosol provision system 10, e.g., if the article 30 is integrally formed with the aerosol provision device 20.

As above, the receptacles 160 may be located outside, for example on a pavement or road, and/or inside a building, for example inside a shop where articles 30 are sold or inside an office. The receptacles 160 may also form part of a larger recycling bin, with one receptacle 160 for articles 30 of aerosol provision systems 10 and other receptacles for other products, such as batteries, glass or plastics. The receptacles 160 may be distributed around an area to create a network of receptacles 160 such that the distance a user need to travel to find/reach a receptacle 160 is minimised. The receptacles 160 are configured to communicate with the aerosol provision system 10 and/or the computer device 40 via the network 50. For example, each receptacle 160 can comprise a communications interface configured to communicate with device control circuitry 28 of the aerosol provision device 20 and the computing device 40 via the network 50. The receptacles 160 can communicate using a suitable wireless communications protocol such as Wi-Fi, Bluetooth, RFID, NFC. As with the implementation described in FIG. 2, the recycling centre 70 is similarly configured to communicate with the receptacles 160 via the network 50, for example using a suitable wireless communications protocol such as Wi-Fi, Bluetooth, RFID, NFC.

When an article 30 has reached the end of its usable life (e.g. as determined according to any of the implementations described in respect of FIG. 2), the user of the aerosol provision system 10 is able to place, drop or otherwise deposit the article 30 into the receptacle 160. However, unlike the receptacle 60 of FIG. 2, the receptacle 160 of FIG. 4 is configured to determine when the weight of the articles 30 placed, dropped or deposited therein reaches a storage limit. For example, the receptacle 160 may be configured to determine or otherwise measure the weight of a portion of the receptacle 160 for receiving the articles 30, and compare the weight against the associated storage limit. The receptacle 160 may be configured to determine the weight of the portion of the receptacle 160 for receiving the articles 30 and compare the combined weight against a storage limit, or the receptacle 160 may be configured to determine a change in weight from an empty condition of the portion of the receptacle and compare the change in weight to a storage limit. It should be appreciated that the determined or otherwise measured weight is indicative of the capacity of the receptacle 160 for receiving further articles 30.

In response to the weight of articles received by the receptacle 160 meeting the storage limit, the receptacle 160 is configured to send a notification to the recycling centre 70 or to one or more devices associated with the recycling centre 70 to indicate the receptacle 160 has articles for collection. As described above, the receptacle 160 can communicate with the recycling centre 70 via the network 50. In addition, or alternatively, the receptacle 160 may communicate with one or more devices associated with the recycling centre, e.g., one or more smartphones belonging to registered employees of the recycling centre 70. In this case, the receptacle 160 may be provided with communication details (e.g., telephone numbers, IP addresses, etc.) associated with the one or more devices, which may be obtained from a server (not shown) coupled to the network 50 or from the recycling centre 70. Alternatively, such notifications may be forwarded from the recycling centre 70 to the one or more devices associated with the recycling centre.

In response to receiving the notification, the articles can be sent or otherwise transported from the receptacle 160 to the recycling centre 70 (as described above with respect to FIG. 2).

The receptacles 160 can store the articles 30 after having received the articles 30 and before the articles 30 are collected and sent to the recycling centre 70. The articles 30 can be stored in bags, boxes, tanks or other storage means of the receptacle 160 (as described above with respect to FIG. 2).

It should also be appreciated that the additional functionality of the receptacles 60 described in connection with the implementation of FIG. 2 may also be implemented by the receptacles 160 of FIG. 4. For example, the receptacle 160 can communicate with the aerosol provision device 20 and/or the computing device 40 to provide a location of the receptacle 160 to the aerosol provision device 20 and/or the computing device 40, or to signify to the aerosol provision device 20 and/or the computing device 40 when the user passes approximate to a receptacle 160. Additionally or alternatively, a shipping label can be generated and provided to the user by the receptacle 160, for example from a printer of the receptacle 160.

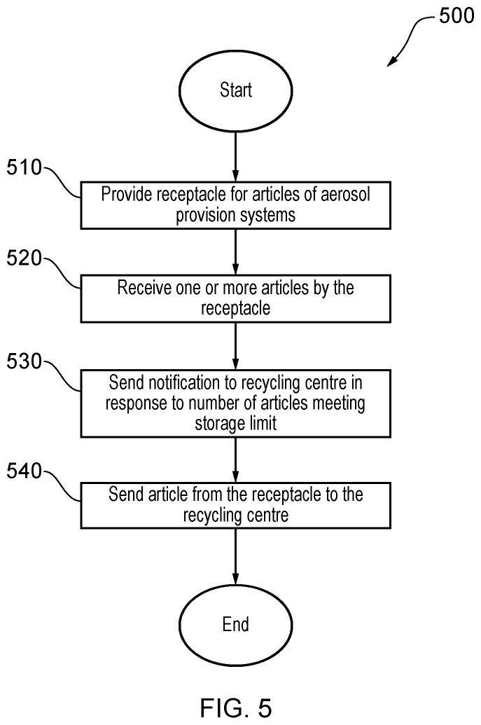

FIG. 5 is a flow diagram of a method 500 for recycling articles of an aerosol provision system, for example article 30. The method begins at step 510, where a receptacle for articles of aerosol provision systems is provided. At step 520, one of more articles are received by the receptacle. At step 530, a notification is sent to a recycling centre in response to the weight of articles received by the receptacle meeting a storage limit. The notification indicates the receptacle has articles for collection. At step 540, the articles are sent from the receptacle to the recycling centre. The method then ends.

As described above, the present disclosure relates to (but is not limited to) a recycling method comprising providing a receptacle for receiving at least articles of aerosol provision systems, receiving, by the receptacle, one or more articles, in response to the weight of articles received by the receptacle meeting a storage limit, sending a notification to a recycling centre or to one or more devices associated with the recycling centre to indicate the receptacle has articles for collection, and sending the articles from the receptacle to the recycling centre.

Thus, there has been described a recycling method and a recycling system.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A recycling method comprising:
providing a receptacle for receiving at least articles of aerosol provision systems;
receiving, by the receptacle, one or more articles;
in response to the number of articles received by the receptacle meeting a storage limit, sending a notification to a recycling centre or to one or more devices associated with the recycling centre to indicate the receptacle has articles for collection; and
sending the articles from the receptacle to the recycling centre.

2. The method of claim 1, further comprising providing a user of an aerosol provision system a shipping label for adhering to the article prior to the receptacle receiving the article from the user.

3. The method of claim 1, wherein the receptacle comprises one or more bags for receiving the articles, and where in the bags are sealed prior to sending the articles to the recycling centre.

4. The method of claim 1, further comprising providing a notification to the user in response to the user passing proximate to the receptacle.

5. The method of claim 1, wherein the articles are integrally formed with an aerosol provision device to form an aerosol provision system, and wherein sending the notification to a recycling centre or to one or more devices associated with the recycling centre to indicate the receptacle has articles for collection includes sending the notification a recycling centre or to one or more devices associated with the recycling centre in response to the number of integrally formed articles and aerosol provision devices received by the receptacle meeting a storage limit.

6. A method for notifying when a receptacle for receiving at least articles of aerosol provision systems reaches a storage limit, the method comprising:
providing the receptacle for receiving at least articles of aerosol provision systems;
determining when the number of articles received by the receptacle meets a storage limit; and
in response to the number of articles received by the receptacle meeting the storage limit, sending a notification to a recycling centre or to one or more devices associated with the recycling centre to indicate the receptacle has articles for collection.

7. A recycling system comprising:
a recycling centre; and
a receptacle configured to:
receive one or more articles for aerosol provision systems; and
send, in response to the number of articles received by the receptacle meeting a storage limit, a notification to the recycling centre to indicate the receptacle has articles for collection;
wherein the articles are sent from the receptacle to the recycling centre in response to the notification.

8. A receptacle configured to:
receive one or more articles for aerosol provision systems; and
determine when the number of articles received by the receptacle meets a storage limit; and
in response to the number of articles received by the receptacle meeting the storage limit, send a notification to a recycling centre or to one or more devices associated with the recycling centre to indicate the receptacle has articles for collection.

9. A recycling method comprising:
providing a receptacle for receiving at least articles of aerosol provision systems;
receiving, by the receptacle, one or more articles;
in response to the weight of articles received by the receptacle meeting a storage limit, sending a notification to a recycling centre or to one or more devices associated with the recycling centre to indicate the receptacle has articles for collection; and
sending the articles from the receptacle to the recycling centre.

10. The method of claim 9, further comprising providing a user of an aerosol provision system a shipping label for adhering to the article prior to the receptacle receiving the article from the user.

11. The method of claim 9, wherein the receptacle comprises one or more bags for receiving the articles, and where in the bags are sealed prior to sending the articles to the recycling centre.

12. The method of claim 9, further comprising providing a notification to the user in response to the user passing proximate to the receptacle.

13. The method of claim 9, wherein the articles are integrally formed with an aerosol provision device to form an aerosol provision system, and wherein sending the notification to a recycling centre or to one or more devices associated with the recycling centre to indicate the receptacle has articles for collection includes sending the notification a recycling centre or to one or more devices associated with the recycling centre in response to the weight of integrally formed articles and aerosol provision devices received by the receptacle meeting a storage limit.

14-16. (canceled)
